(19) United States
(12) Patent Application Publication
(10) Pub. No.: US 2013/0031018 A1
(43) Pub. Date: Jan. 31, 2013

(54) METHOD AND ARRANGEMENT FOR MONITORING COMPANIES

(71) Applicant: Harald Jellum, Baerums Verk (NO)

(72) Inventor: Harald Jellum, Baerums Verk (NO)

(21) Appl. No.: 13/637,471

(22) PCT Filed: Mar. 29, 2011
(86) PCT No.: PCT/NO2011/000109

§ 371 Date: Sep. 26, 2012

(30) Foreign Application Priority Data
Mar. 29, 2010 (NO) 20100464

(51) Int. Cl. G06Q 10/00

(52) U.S. Cl. 705/348

(57) ABSTRACT

Method and arrangement for matching of enterprises and detection of changes for an enterprise by the use of mathematical models that make it possible to match and find similarities between enterprises and also discover changes in an enterprise. The method uses mathematical representation models for enterprises and is suited to make a large number of comparisons automatically. The characteristics of the enterprises are represented by different vectors (74). The direction and length of the vectors are compared by taking the scalar product between them (76). Changes for the characteristics of an enterprise appear as changes in the direction and length of the vectors. By continuously monitoring the derivative of the characteristics of the enterprises this show how large and how quickly a change has occurred (78). The market for the invention is local and global enterprises that wish to find new customers, partners, distributors or other business contacts and also discover changes for in their customers, partners or other business contacts so that they can get an early warning of larger changes that will have consequences for the relationship.

The invention is a completely new way to match and find similarities and characteristics between two or more enterprises and also discover changes in an enterprise. The method uses mathematical representation models for enterprises and is very well suited for making a large number of comparisons automatically for a computer program. The market for the invention is local and global enterprises that wish to find new customers, partners, distributors or other business contacts and also to discover changes in its customers, partners or other business contacts so that they can get an early warning of larger changes that may have consequences for the relationship. This can be, for example, that some of your customers get into great financial difficulties which results in you wanting to handle payment in a different way. The invention will be applicable to all sizes of enterprises and their employees. The enterprises can be public or private. The invention is provided to users via a portal on the internet.

### PRIOR ART

Today's traditional methods to find other enterprises that have a certain set of characteristics, for example, similarity to another enterprise or to discover changes, is often vey manual and comprises looking at several sources of information and where you must perform a manual comparison yourself. Typical are:

Entries in Catalogues:

Today there are many catalogue services where one can find the name, address, phone number, etc of enterprises. Many of these also have the possibility of sorting and entry according to sectors. Examples of these services can be Yellow pages, 1881, Kompass, Your district, Summa, and others. Typical for these is that they contain information based on public registers (for example, from the Norwegian Business register in Brønnøysund). These are often short on detailed descriptions of the characteristics (product, services, market, size, finance . . . ) There are also a number of catalogue services for pure financial entries which tend to rely on submitted accounts. Examples of these are, for example, Purehelp.no and Proff.no.

Much of the challenge with these catalogue searches is that it is relatively time consuming and that it requires much manual labour both in looking them up and in the comparison itself. In addition, they are often short on essential details about the characteristics of an enterprise which means that one does not find what one is after. For very many enterprises the result of this is that they very rarely carry out a systematic search as it is too resource demanding.

Looking up and searching for enterprises with a certain set of characteristics can be made via searches according to key words with the use of internet search engines such as Google, Bing or others. The advantage here is that one can often search in more detail than with the catalogue searches as the internet search engines often have indexed all the web pages of an enterprise. The challenge here is then that one often gets so many hits which are considered to be noise and it is very time consuming to separate these out. Another big challenge is that one can not search for too many characteristics at the same time as the probability is very small that the combination of words one uses is present on the web pages of an enterprise. This often results in missing out on many hits because the enterprise has probably used other words to describe its characteristics than those you have in your key word combination. At the same time, they are short on information about finance, size, sector which means that you have to go to a catalogue afterwards. This is also a very time consuming and manual process.

Fairs and Exhibitions

This has traditionally been an arena for finding new customers, partners or other business contacts. If one is an exhibitor the people passing by will see what you are doing and make contact with you. Or you can wander around yourself to see what others are doing to take contact with them if they have the correct characteristics. This is also very manual and time consuming, and also that the selection is made from those present only. Today, one sees trends within a number of sectors that this is replaced by visibility on the internet and by manual searches via search engines.

Marketing

This is another traditional way to find new customers, partners or other business contacts. One tries through marketing such as, for example, advertising for others with the same wanted characteristics. These will then make contact and you can decide yourself whether they have the desired characteristics. The challenge with this is that it is often very costly.

Social Media

There are today a number of dating portals for private individuals where one can describe oneself via a number of questions and then get an automatic suggestion of other people that match you as they have also replied to the same questions. These matching methods are often based on a set of “manual rules” which are programmed in. The challenges here are that everyone must have answered the questions first and that this, to a very small extent, exists for enterprises with all the characteristics which they have. Such a solution is described in US2003/0131120.

Discovering Changes in the Characteristics of an Enterprise Today there are very few methods which does this by any other way than manual searching as described above. The exception is in pure financial monitoring where there are programmes which compare the last submitted accounts with previous submissions. In this way you can subscribe to services that give you a warning if an enterprise is no longer credit worthy, etc. The challenge with this service is that it does financial characteristics only and they are often somewhat old in that the accounts are often submitted annually for many enterprises. In US2009/0327914 a system is described for detection of changes in information regarding internet pages.

### WHAT IS ACHIEVED IN RELATION TO PRIOR ART

Based on what is available of different methods today to find other enterprises with a given set of characteristics, this invention contains a completely new method to be able to match and find other enterprises with the required characteristics by using a mathematical model that is very well suited to automatic matching between two or more enterprises. This same model also provides a possibility to more easily discover changes, and thereby with the help of the changes in the characteristics of the enterprises contribute to the detection of new customers, partners, competitors or other business contacts or the detection of new markets based on trends within changes in markets and products for other enterprises.

The aim of the invention is thereby realised by a method and a system as given above and characterised as described in the independent claims.

In general, a method and a system is thereby realised for matching of enterprises and detection of changes in an enterprise by the use of mathematical models that make it possible to match and find similarities between enterprises and also to discover changes in an enterprise. The method employs mathematical representation models for enterprises and is suited to make a large number of comparisons automatically. The characteristics of the enterprises are represented by different vectors (74). The direction and length of the vectors are compared by taking the scalar product between these (76). Changes in the characteristics of an enterprise emerge from changes in the direction and length of the vectors. By continuously monitoring the derivative of the characteristics of the enterprises this will show how large and how quickly a change has taken place (78). The market for the invention is local and global enterprises that wish to find new customers, partners, distributors or other business contacts and also discover changes in their customers, partners or other business contacts so that they can get an early warning about larger changes that will have consequences for the relationship.

The invention will be described below with reference to the enclosed figures that describe the invention with the help of examples.

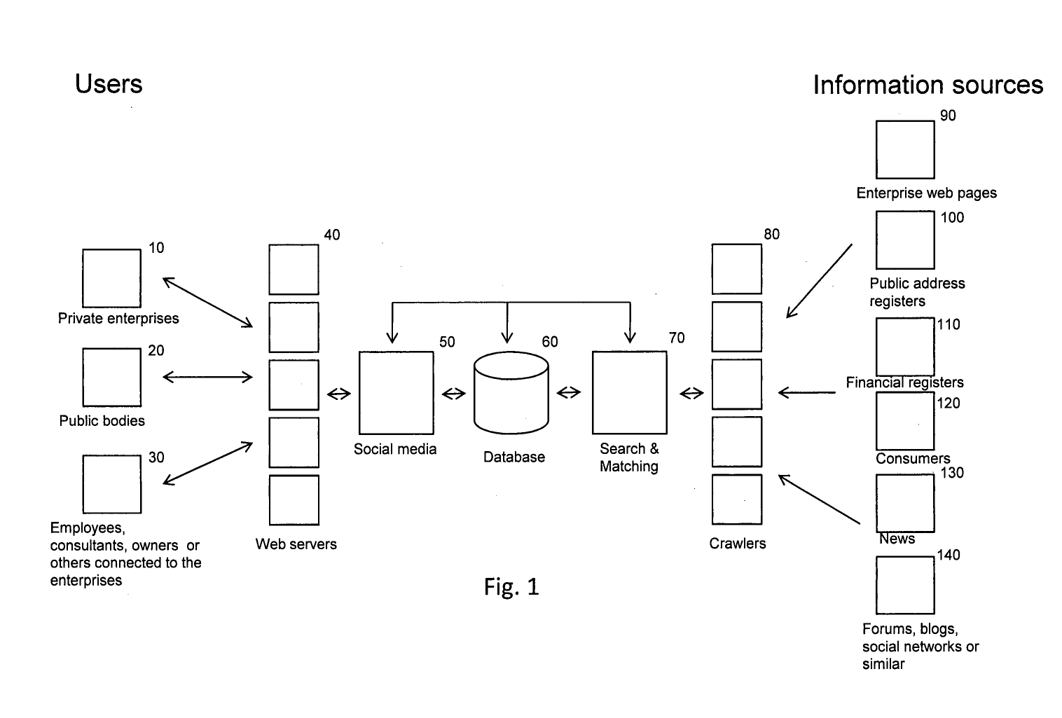

FIG. 1 shows an overview of the system where the invention is incorporated.

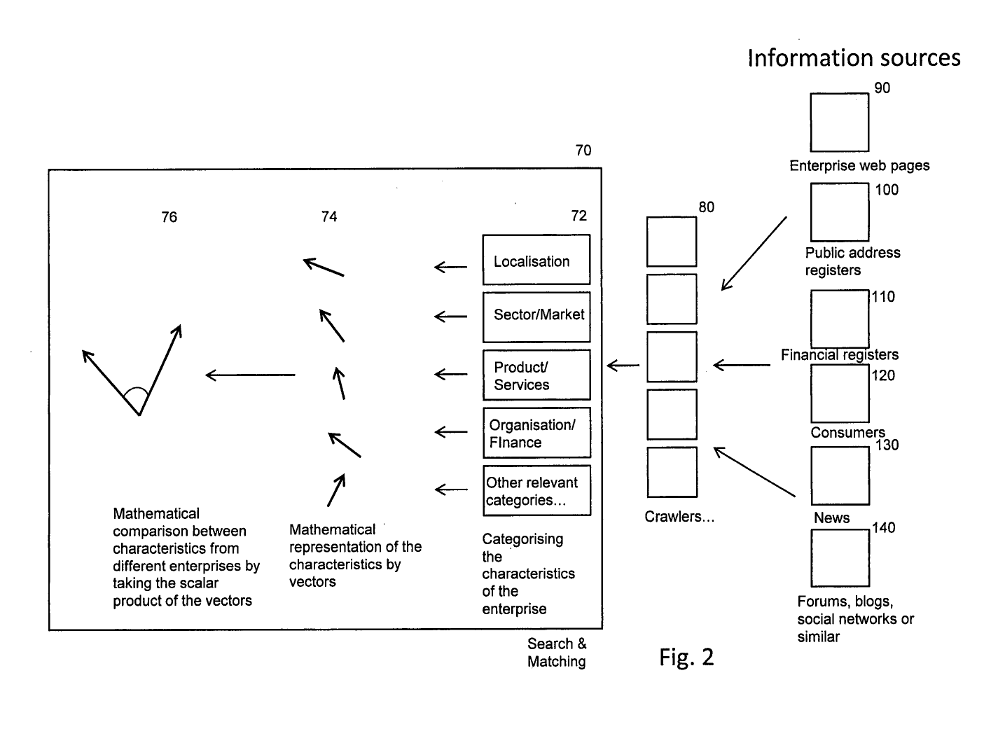

FIG. 2 illustrates the method for searching and comparing the information from different sources.

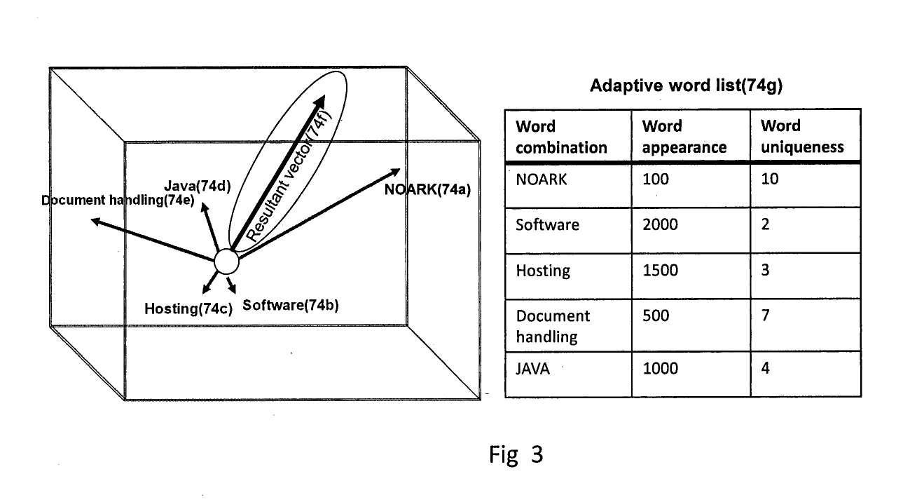

FIG. 3 shows an example of the product characteristics for an enterprise. The example is an enterprise which makes software for handling of documents in JAVA for Norwegian Archive Standard (NOARK) and which is hosting.

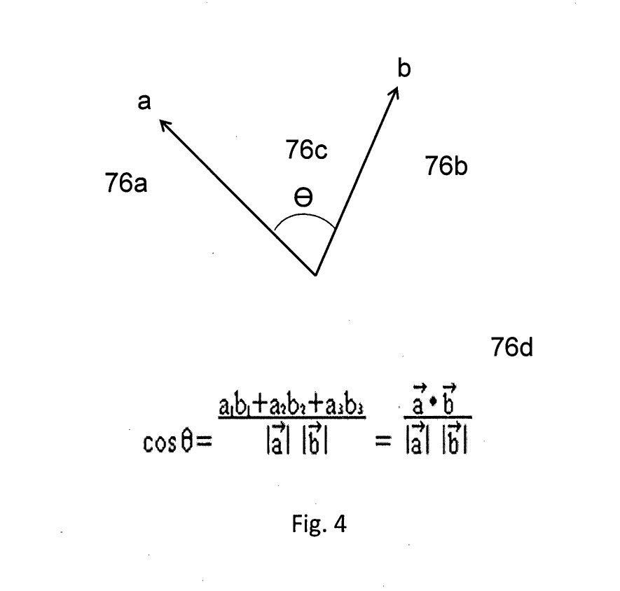

FIG. 4—illustrates mathematical comparison between the characteristics of two enterprises.

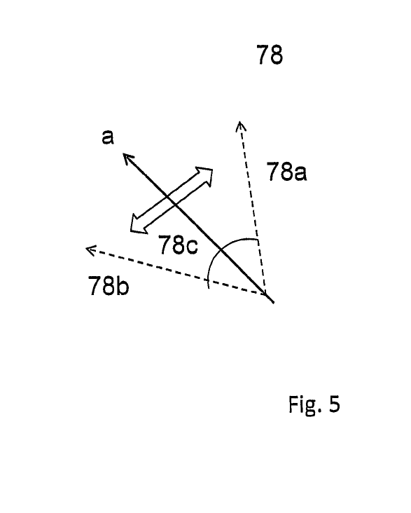

FIG. 5—illustrates mathematical change in the characteristics of an enterprise.

### MEANS THAT ARE NECESSARY

The invention employs vector mathematics in a new combination for representing information about an enterprise collected with the help of search engine technology.

### INDUSTRIAL APPLICATIONS

The invention can lead to a completely new method to match and find similarities and characteristics between two or more enterprises and also discover changes in an enterprise. This can mean considerable savings in relation to the method being used today to get new businesses. Very often these are today manual and time consuming processes which can now be replaced by systematic and automatic processes.

### DESCRIPTION OF THE INVENTION

Based on all of the above, there is a need for a more efficient way to match and find similarities and characteristics between two or more enterprises and also discover changes in an enterprise. The above mentioned problems are addressed by the invention that is described in the following.

The invention is based on the use of a database, advanced search & matching technology by the use of mathematical models combined with social media. Starting with FIG. 1, the invention comprises a server farm comprising servers for Crawlers (80), Search & Matching (70), Database (60), Social media (50) and Web servers (40). The aim of the Crawlers (80) is initially to read all the sources of information (90,100,110,120,130,140) and where the Search & Matching (70) will make a mathematical model of the characteristics of each enterprise. Thereafter, the Crawlers (80) will continuously read all the information sources (90,100,110,120,130,140) for changes and updates. These adjust the mathematical models and are stored in the Database (60).

The information sources (90,100,110,120,130,140) comprise the Web pages (90) of the enterprises that are crawled in the same way as from a standard search engine. Public registers (100) and financial registers (110) are both available registers for addresses, contacts and financial information such as accounting and credit information. Some of the registers will be public, while others can be private and access must be purchased. There may be several registers within each of the information sources (100,110). The users (120) can be other enterprises, employees or private individuals that provide feedback on an enterprise. News (130) comprises a stream of news which is continuously updated with news from newspapers, magazines, radio, TV, organisations, local authorities, directorates, political parties or the like. This service is provided by available third party suppliers in the market (for example, MoreOver, Retriever, Cyberwatcher or others).

In the same way as for News (130) one will also get a steam of news from Forums, Blogs, Social Networks (140) delivered by third party suppliers. The users (10,20,30) of the invention will reach the invention via an internet portal that is made available via Web servers (40). When the database (60) has received all the information from the sources of information (90,100,110,130,140) with the exception of Users (120), which will arrive en route when the invention is taken into use, all users (10,20) will receive a personalised e-mail (from e-mail addresses from the Web pages (90) of the enterprises and/or public registers (100)). This e-mail links to a profile of the enterprise that is already set up and which makes you into a user in the course of a few clicks. As a user of the invention you can now invite your customers, partners or other business contacts to be part of your customer group, partner group or other groups that you may have set up. This is similar to other social media for private individuals. In this way you create a network of your business contacts. One of the unique characteristics of this invention is that with all this information from all the sources of information (90,100,110,120,130,140), your network which you have created via the social media (50) and with Search & Matching (70) in combination with Database (60) is automatically to be able to suggest new customers, partners or other business contacts that match your need.

The Search & Matching method and arrangement of the invention is described in FIGS. 2, 3, 4 and 5 that are described in the following. In FIG. 2—Search & Matching overview is information about the enterprises from the Crawlers (80). This information is categorised (72) according to where it comes from and what kind of information it is. It can be information about where the enterprise is located, which sector/market they operate in, what kind of products and services they provide, organisations/finance or other categories. Each of these characteristics which are now categorised (72) is now represented mathematically with the help of its own vector that has a direction and length in a multi-dimensional space (74). The characteristics for an enterprise can now easily be compared by comparing direction and length by taking the scalar product between two vectors (76). In FIG. 3—Mathematical representation of an enterprise's characteristics, we see how a such characteristic vector is built up.

FIG. 3 shows an example of the product characteristic of an enterprise. The figure illustrates how each word that describes the product is represented with its own vector (74a, 74b, 74c, 74d, 74e). Each of the unique words (part characteristics) has its own direction in the multi-dimensional room (in the figure only three directions are illustrated). The length of each of these part characteristics (74a, 74b, 74c, 74d, 74e) is dependent on how unique each word is. The words (part characteristics) with the greatest uniqueness have the longest length of the vectors.

In FIG. 3 we see that NOARK (74a) is the longest vector as this is the most unique word. To keep an order on how unique each word (part characteristics) is, an adaptive wordlist (74g) is made that arranges all the words that are crawled (80) from all the information sources (90-140 from FIG. 1) for all the enterprises. This adaptive wordlist (74g) counts the number of times a word (part characteristic) appears for all enterprises. The difference is inversely proportional to the number of appearances. The words (part characteristics) that appear the least are the most unique. In the adaptive wordlist (74g) we see that NOARK is the most unique with 10, while software is the least unique with a relative value of 2. In addition to the word uniqueness one also counts the number of appearances of the word within one enterprise. If there are many appearances the length of the vector also increases. If the words are more central in the text, for example, in the heading or with extra large letters, this can be given additional importance so that the vector also can increase its length. One can also put together several words to one vector. This means in practice that one gets several more directions, but the principles are the same. To make a mathematical expression for the characteristics of an enterprise all the part characteristics vectors (74a, 74b, 74c, 74d, 74e) are added to give a resultant vector (740 which is the sum of all the others. This resultant vector (740 is a fingerprint or mathematical expression of the characteristics of an enterprise. One can also combine several characteristics to make new fingerprints for combinations of characteristics. One can, for example, add together all the different characteristic vectors (74) such as for product, market, organisation/finance or other relevant characteristics to a main vector for the whole of the enterprise.

In FIG. 4—Mathematical comparison between the characteristics of two enterprises it is shown how two enterprises are represented by their own vector a (76a) and b (76b) and are compared by taking the scalar product between the vectors as shown by a mathematical equation in FIG. 4 (76d). The scalar product is an expression for the direction (angle between the vectors) and length of the vectors. The characteristics of two enterprises that point in the same direction and are relatively of the same length are two enterprises with the same characteristics. By searching after enterprises and matching between these the similarity given with an expression converted to 0-100% that corresponds to the result from the scalar product. This makes it much simpler for the user to read how similar two enterprises are to each other. In FIG. 3 we see how the characteristics of an enterprise are represented with the help of a mathematical vector.

FIG. 5 shows change in the characteristic of an enterprise in that the vector changes. The change occurs in the form of a change in length and/or direction. By considering the “derivative” of the characteristic (vector) of the enterprise one can see the degree of change.

As the sources of information (90-140) from FIG. 1 are read continuously and the associated vectors are calculated continuously all changes will influence direction and length for the characteristics of an enterprise. By continuously following how fast and large these changes are, this will reflect the nature of the change. This is carried out by continuously “taking the derivative of” the characteristics of the enterprise or measuring how large the changes in the vector are. This is illustrated in FIG. 5 where vector a (78c) varies in direction and length given by the lower dotted line (78b) or direction and length given by the upper dotted line (78a). The magnitude of this deviation (78c) is given by the derivative of the vector and is an expression for how large the change has been for one enterprise. This change can be, for example, that an enterprise launches a new product, changes financial status, changes market or location or other relevant changes. If these changes concern some of your partners, customers or other business contacts that you have coupled together in your social network (50) you will be able to receive an early warning about them. In this way, you can automatically get hints about changes very quickly and be in a position to act if this is called for.

To sum up, the invention relates to a method and an arrangement for matching of enterprises and detection of changes for an enterprise by the use of mathematical models that makes it possible to match and find similarities between enterprises and also discover changes in an enterprise. The method and arrangement can preferably be comprised of:
a) Combination of enterprise information collected by search engine technology, and where the characteristics of the enterprise are represented with the help of vector mathematics developed by a mathematical analysis of the information. This analysis can be carried out by, by and large, known solutions for multi-variable analysis.
b) The search engine continuously reads the web pages (90) of enterprises, public enterprise registers (100), financial registers (110), news (130) forums (140), blogs (140), social networks (50) and feedback from the users (120). The information can be stored for longer storage or immediate further processing.
c) The collected and stored information is categorised (72) in a categorising unit as characteristics within the areas such as location, sector, market, product, services, organisation, finance or other relevant categories that can be defined depending on the system and contain the usual indicators of the operation of an enterprise.
d) The collected information is analysed in a calculation unit to provide mathematical vectors that represent the characteristics (74) of the enterprise.
e) Different enterprises can thereby be compared in a comparison unit by calculating the scalar product (76) between the characteristic vectors of an enterprise and comparison of direction and length of the characteristic vectors.

In a preferred embodiment of the invention it can also be incorporated that changes in the characteristic of an enterprise can be expressed as changes in characteristic vector with speed, length and direction (78).

The method and arrangement further comprise that the characteristic of an enterprise can be represented as a vector (74) in a multi-dimensional space where each direction represents a unique word or part characteristic. The characteristic vector of this enterprise can be comprised of the sum of each part characteristic which encompasses the vectors represented by one or more unique words or combination of words (74f).

A part characteristic vector (74a) can have, for example, a length which is inversely proportional to the total appearance of words given by an adaptive wordlist (74g) and proportional to the appearance, location, size or meaning within one enterprise.

Different words can also be given different weight, either as a result of an analysis of a special field or a direct choice by a user or operator. The comparison between one or more enterprises can then be made for example, by taking the scalar product (76d) which is converted into a readable value between 0-100%.

A change in an enterprise is represented as changes in direction and length for the characteristic vector of the enterprise which is made by looking at the derivative of a vector (78). Thus, size and direction of a change in relation to the starting point can also be included in the analysis as characteristics. The changes in the vectors of an enterprise can lead to an early warning, about ongoing changes that are sent as a message to the users. This can be particularly useful if the vector changes reflect positive or negative directions for an enterprise, for example, by detecting economic changes of the enterprises, market trends and state of the market changes.

The vectors of the enterprises are preferably based on information from forums, blogs, social networks (140), news (130) or users (120) and can give a live indication of the product, service and brand status of an enterprise and its development in a positive or negative direction by a comparison with defined positive and negative vectors.

The characteristic of an enterprise is represented as a vector with a normalised length by storage in a database (60) and the length itself can be calculated dynamically by a comparison of the point in time for the whole to reflect the adaptive wordlist (74g) which all the time is updated by crawling the sources of information (90-140). An enterprise vector can comprise one or more characteristic vectors (74) of the enterprise.

An enterprise, preferably a member of the network, can overrule the length of a vector that is given by the adaptive wordlist (74g) due to other priorities which are important for the enterprise, such as campaigns, strategy changes, visibility or other business reasons.

The enterprise matching can combine vector comparisons with several other parameters such as, regulations, external influences, strategies or other wishes that are of consequence for the enterprise or its surroundings. It can also be restricted to members of the system such that these can control the criteria that are used in the network. The system can also be set up so that the vectors of the enterprise that have relatively the same direction and length automatically can form groups of enterprises that have many common features. This can lead to suggestions of contact between enterprises in the group or be used as a criterion for the assessment of others, for example, about a possible collaboration with one or more of them.

1. A method for comparing enterprises and detection of changes in an enterprise comprising server means adapted to use mathematical models that make it possible to match and find similarities between enterprises and also to discover changes in an enterprise and a database for storing the characteristics of the enterprises, the method comprising the following steps:
a combination of information about an enterprise collected by search engine technology and where the characteristics of the enterprise are represented with the help of vector mathematics;
b) wherein the search engine continuously reads the web pages of the enterprises, public enterprise registers, financial registers, news, forums, blogs, social networks and feedback from the user;
c) wherein the information is categorised as characteristics within location, sector, market, product, services, organisation, finance or other relevant categories;
d) and which are converted into mathematical vectors that represent the characteristics of the enterprise, the vectors being stored in the database; and
e) wherein the enterprises are compared by comparing the scalar product between the characteristic vectors of the enterprise.

2. The method according to claim 1, wherein changes in the characteristics of an enterprise are expressed as changes in a characteristic vector with speed, length and direction.

3. The method according to claim 1, wherein a characteristic of an enterprise is represented as a vector in a multi-dimensional room where each direction represents a unique word (part characteristic).

4. The method according to claim 3, wherein the characteristic vector of an enterprise comprises the sum of each part characteristic which encompasses vectors represented by one or more unique words or compositions.

5. The method according to claim 4, wherein a part characteristic vector has a length which is inversely proportional to the appearance of all the words given by an adaptive wordlist and proportional to the appearance, location, size or meaning within an enterprise.

6. The method according to claim 1, wherein a comparison between one or more enterprises is made by the scalar product which is converted to a readable value between 0-100%.

7. The method according to claim 1, wherein a change in an enterprise is represented as changes in direction and length of a characteristic vector of an enterprise that is created by regarding the derivative of a vector.

8. The method according to claim 1, wherein the characteristic of an enterprise is represented as a vector with a normalised length by storing in a database and that the length itself is calculated dynamically at the time of the comparison, to the whole time reflect the adaptive wordlist which all the time is updated by crawling of the information sources.

9. The method according to claim 1, wherein an enterprise vector can comprise one or more of the characteristic vectors of an enterprise.

10. The method according to claim 1, wherein an enterprise can overrule the length of a vector which is given by the adaptive wordlist due to other priorities that are important for the enterprise such as campaigns, strategy changes, visibility or other business reasons.

11. The method according to claim 1, wherein an enterprise matching can combine vector comparison with several other parameters such as regulations, external influences, strategies or other wishes that are important for the enterprise or its environment.

12. The method according to claim 1, wherein changes in an enterprise vector can lead to an early warning which is sent as a message to the users.

13. The method according to claim 1, wherein the vectors of enterprise that have relatively the same direction and length can automatically form groups with enterprises that have many features in common.

14. The method according to claim 1, wherein changes in the vectors of an enterprise can detect market trends and market changes.

15. The method according to claim 1, wherein changes in the vectors of enterprises can detect positive or negative directions for an enterprise.

16. The method according to claim 1, wherein changes in the vectors of enterprises can detect new customers, partners, competitors or other business contacts.

17. The method according to claim 1, wherein changes in the vectors of enterprises can detect new markets based on trends within the changes in the market and products of other enterprises.

18. The method according to claim 1, wherein the vectors of enterprises based on information from forums, blogs, social networks, news or users can provide a live indication of the product, services and brand status of an enterprise and its development in positive or negative directions by comparing with defined positive and negative vectors.

19. A system for matching of enterprises and detection of changes for an enterprise with the use of mathematical models that make it possible to match and find similarities between enterprises and also discover changes in an enterprise, the system comprising:
a) a search engine connected to a network set up for collecting enterprise information;
b) wherein the search engine is set up to essentially continuously read the web pages of enterprises, public enterprise registers, financial registers, news, forums, blogs, social networks and feedback from the users;
c) a categorising unit set up to categorise the information collected by the search engine within location, sector, market, product, services, organisation, financial or other relevant categories;
d) a calculation unit set up to make the categorised information to mathematical vectors that represent the characteristics of an enterprise; and
e) a comparing unit for comparing the enterprises stored in the memory by taking the scalar product between the characteristic vectors of the enterprise.

20. The system according to claim 19, wherein changes in the characteristics of an enterprise are expressed as changes in characteristic vectors with speed, length and direction.
